(19) United States
(12) Patent Application Publication
(10) Pub. No.: US 2019/0003750 A1
(43) Pub. Date: Jan. 3, 2019

(54) DEVICE FOR ABSORBING THERMAL ENERGY FROM THE SURROUNDING ENVIRONMENT AND USING SAME (GENERATOR)

(71) Applicant: Mahmoud Tharwat Hafez AHMED, Luxor (EG)

(72) Inventor: Mahmoud Tharwat Hafez AHMED, Luxor (EG)

(21) Appl. No.: 16/063,298

(22) PCT Filed: Dec. 15, 2016
(86) PCT No.: PCT/EG2016/000039

§ 371 Date: Jun. 18, 2018

(30) Foreign Application Priority Data
Dec. 17, 2015 (EG) 2015/1999

(51) Int. Cl. F25B 27/00; F03G 7/04; F25B 9/14

(52) U.S. Cl. CPC F25B 27/00; F01K 25/06; F25B 9/14; F03G 7/04

(57) ABSTRACT

Existing turbine energy generators currently use temperature difference to do work. To operate, they require a boiler, a condenser that usually operates at normal temperatures, a turbine, and a pump for increasing the fluid pressure, said generators mostly using water as a cooling medium. The invention is based on lowering the temperature of the condenser, such that the boiler can operate under normal operating conditions. In order to do this, 1) a cooling medium having a low boiling temperature (below 0) is used instead of water; 2) the temperature of the condenser—which is well insulated—is lowered to said temperature by using a normal secondary cooling cycle between the evaporator and the condenser, the cooling cycle transferring the excess heat from the condenser to the evaporator without the need for external cooling—this cycle uses a second cooling medium having a temperature slightly below that of the first cooling medium.

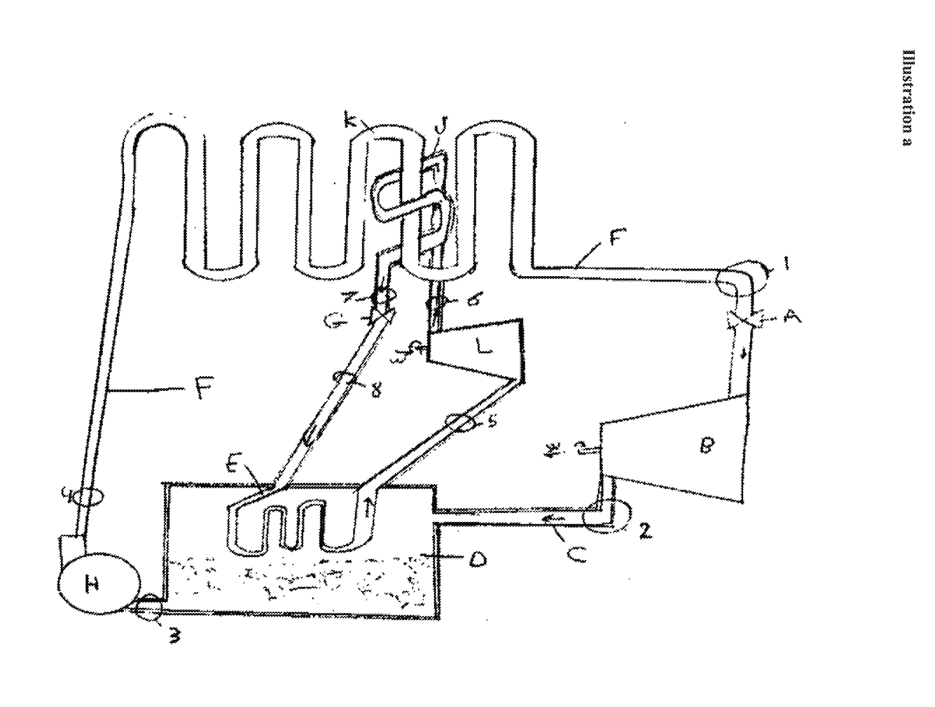

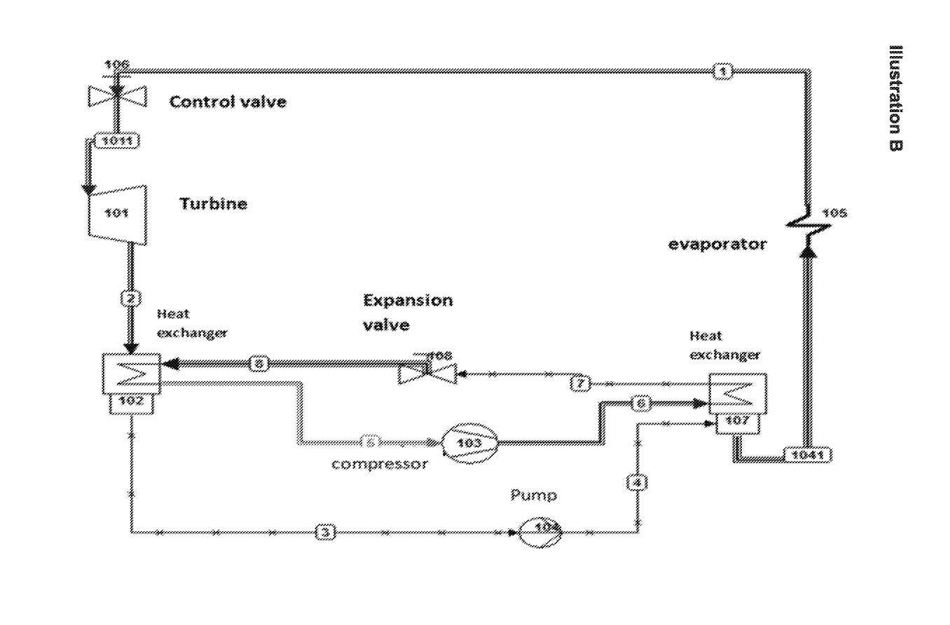

### PRIOR ART

1. Refrigeration and Air Conditioning

Refrigeration and air conditioning work on increasing gas pressure to turn it into a liquid when it loses some heat—that heat comes mostly from gas compression process—to the outside air and that liquid goes through expansion valve allows the liquid to become cold gas again to gain heat from surrounding—ex. inside the room.

### Problem or Deficiency in the Prior Art

The global warming problem roiling the world, also energy consumption is increasing every day and in turn more search for clean, renewable energy is needed.

While refrigeration and air conditioning especially important in Arabic countries, lacking the technology to efficiently cooling with high temperatures over 50 degrees Celsius, also it consumes a lot of electricity and energy and heating the surrounding weather plus Use some harmful compounds (Freon) to the ozone layer.

On the other hand might be acceptable logically burning wood to heat the air or getting warmer or use the fireplace for heating or boiler or using heat to generate electricity through turbines Etc but it is a little weird energy use for cooling air.

### New in the Subject Invention

Device design converts air heat to kinetic energy to cool air at he same time can be used to produce energy.

### DETAILED DESCRIPTION

The turbine power plant—Rankin power plant—composed of boiler converts water into steam—point 3.

That steam goes to the turbine which coverts heat energy to kinetic energy and the pressurized steam become water vapor with low pressure and temperature—point 4.

That vapor enters the condenser it turns into liquid after losing some of its heat—1 point.

The liquid water goes to the pump to raise its pressure before it enters the boiler again—point 2.

In order to make the boiler turns to evaporator i.e. to absorb ambient heat we must make changes

1. use a low boiling point cooling medium

2. decrease the condenser temperature a little below the boiling point of the cooling medium

Use a low temperature cooling medium has too many choices but I will pick two of them R-134a and R-22, because they are easy to find and the abundance of information about them.

But I think that (nitrogen/air) system would be more suitable for commercial use and eco friendly.

To reduce the temperature of the condenser, we must at first thermally isolate the condenser body from surrounding

Secondly by using artificial cooling cycle to absorb the condenser heat and transfer that heat to the evaporator using second cooling medium with boiling point slightly lower than the first one

### Mode of Action

The cooling medium enters from point 1 at room temperature or higher to the turbine B to convert some of its heat energy to kinetic energy so it will have less temperature and pressure.

The control valve A controls cooling medium quantity entering the turbine B or shut it down completely (thermally insulate the turbine is preferred) after that the cooling medium enters the insulated pipe C—point 2—preferably using vacuum insulation, after that it enters the condensation reservoir D (which is heat exchanger with reservoir) which is very well thermally insulated so that cooling medium condensed at the bottom and sucked by the pump E.

At top of the condensation reservoir D there is a second evaporator E for secondary cooling cycle where working with other cooling medium has boiling point less than that of the main cooling medium.

The compressor L sucks the second cooling medium—point 5—to and compress it to the heat exchanger J—point 6—where it loses extra heat to the main evaporator K (or separate part from it) then it turns to liquid—point 7—then it loses its pressure in the expansion valve G—point 8—and its temperature lowered inside the second evaporator E so the main cooling medium well start to condense inside the condensation reservoir D and the main cooling medium which exits from the condenser—point 3—to pump H and to the evaporator core K—point 4—point where it absorbs the heat from the surrounding.

on this device second cooling cycle should be thermally insulated so the surrounding heat loss/gain don't affect the device balance using variable compression type compressor (can over various pressure) is proffered so it will not waste the energy produced by the turbine and the turbine B body should be insulated.

The device will need to controllers to organize components speed so the compressor L and the pump H has to match the speed of the turbine B (mechanical or electronic controller)

### Device Starting

To start this device the compressor L needs to start for enough time to start the main cooling medium condensation in the condensation reservoir D

But we can make the device runs automatically by installing check valve on the tube between the turbine B and condensation reservoir D and installing another solenoid valve after the pump H (valve opens and closes only) closes when the main valve A closes so some of the cooling medium will still liquid or at high pressure inside the condensation reservoir D.

when the valves opened the pressure difference starts the turbine B and thus the entire device starts automatically

### Calculations

Making this calculations here for this device to make sure it will work or not and because the device based only on paper I will assume certain assumptions realistically accepted—

I: the gas flow rate in any part of the machine is constant and equal to 1 kg/s (run cluster rate equations)

II: the main cooling cycle is R-134a (1-4 point) while secondary cooling cycle is R-22 (5-8)

III: The two cycles are ideal and that means the compressor and pump and turbine and the expansion valve are isentropic while the heat exchangers (evaporator) isobaric

IV: at point 1—P=5 bar And T=25 C (room temperature and relatively acceptable pressure for medium sized pump)

V: at point 2—P=1 bar (Based on the turbine efficiency=15% a value suitable for the small turbine I will use it)

VI: Temperature at point 5—equal to the temperature at point 2—and the temperature at point 8—approximately equals point 3—temperature.

VII: at point 6—P=1.5 bar and at point 8—P=1 bar (I got this hypothesis after trying a number of different pressures upon calculations)

VIII: at point 7—T=−35 (that is the same temperature that R-22 condenses at a pressure 1.5 bar)

In order to be sure the device will work (mathematically) we have to find the difference between the workout resulting from turbine B and work-in exploited by the pump H and the compressor L as we must also make sure that the amount of heat absorbed from the second cycle at the condensation reservoir D is less than heat emitted from that cycle at the main evaporator K.

But first we have to calculate the values of the enthalpy h, entropy s, pressure P and temperature T at every point of the eight points.

By reviewing the previous assumptions and use of site Http://webbook.nist.gov/chemistry/fluid/ for tables of thermodynamics for some cooling media types (including R-134a and R-22)

| | Entropy | Enthalpy | Pressure | Temperature | | Cooling |
|---|---|---|---|---|---|---|
| Notes | S J/g · k | h kJ/kg | P bar | T | Point | medium |
| Values it underlined | 1.75 | 416.4 | 5 | 25 | 1 | R-134a |
| in bold assumed | 1.75 | 383.68 | 1 | −25 | 2 | |
| directly while the | 0.7955 | 148.16 | 1 | −40 | 3 | |
| values in bold with | 0.7955 | 148.44 | 5 | 39.9 | 4 | |
| no line underneath a | 1.866 | 397.45 | 1 | −25 | 5 | R-22 |
| result assume that | 1.866 | 407.03 | 1.5 | −8 | 6 | |
| the cycles are ideal, | 0.84588 | 160.37 | 1.5 | −35 | 7 | |
| other values from | 0.84588 | 153.7 | 1 | −41 | 8 | |
| calculations on the site | | | | | | |
| http://webbook.nist.gov/ | | | | | | |
| chemistry/fluid | | | | | | |

Workout from turbine Wt

wₜ=m(h₁−h₂)=32.72 kJ/s

Where m is mass flow rate and has assumed to be 1 kg/s

The work needed for pump wₚᵤₘₚ And the compressor w_{comp}

wₚᵤₘₚ=m(h₃−h₄)=0.28 kJ/s

w_{comp}=m(h₅−h₆)=−9.58 kJ/s

Net work from the device W

W=wₜ+w_{comp}+wₚᵤₘₚ=22.86 kJ/s

Which means that this device generates surplus energy of about two thirds of the power generated by the turbine.

But there is still two things to check about—

1. Is the second cooling cycle absorbs enough heat to condense the main cooling medium? In the equations does h2−h3 Equals numerically (almost) h5−h8?

h2−h3=235.52 kJ/kg

h8−h5=−243.75 kJ/kg

This outcome confirms that the second cooling cycle will likely able to condense the main cooling medium.

2. Is the main evaporator can absorb heat from the second cooling cycle? and how much heat it will absorb from surrounding after that? to answer we will compare between h4−h1 And h6−h7

h4−h1=−267.96 kJ/kg

h6−h7=246.66 kJ/kg

And be the difference −21.3 kJ/kg (of course near the number of net work) are absorbed from the surrounding and is a good number of course considering the temperature difference and the pressure relatively few.

### Method of Exploitation

Can be used for cooling or air conditioning without the need for an external power source.

Can be used as a source of electricity

Can be used as a drive or motor

Could be exploited to reduce the moisture in the air or in water production to intensify water vapor in the air.

Can be used in this previous stuff individually or collectively

### EXPLAINING THE DRAWING BOARDS

Illustration a

1-8: points of measure—or calculate—pressure and temperature and enthalpy

A: Control valve in the cooling medium quantity

B: Turbine

C: Thermally insulated pipes

D: condensation reservoir (thermally isolated)

E: A second evaporator

F: Non-insulated pipes

G: Expansion valve

H: Pump

J: Heat exchanger (another condenser linked to the main evaporator)

K: The main evaporator

L: Compressor

Illustration b

1-8: points of measure—or calculate—pressure and temperature and enthalpy

106: Control valve in the cooling medium quantity

101: Thermally insulated turbine

102: condensation reservoir heat exchanger (thermally isolated)

107: A second evaporator (heat exchanger) thermally insulated

108: Expansion valve thermally insulated

104: Pump

105: The main evaporator

103: Compressor

1. A device absorbs ambient heat energy and converts it to kinetic or electrical energy composed of Heat exchanger J, evaporator K, turbine B connected to check valve (not illustrated), condensation reservoir D with reservoir (not illustrated) and pump H attached with solenoid valve (not illustrated) uses primary cooling medium and refrigeration cycle between the Heat exchanger J and the condensation reservoir D using secondary cooling medium with boiling point slightly less than the primary one.

2. Device as in the first item have two cooling mediums to power a turbine could start automatically.

3. Device as in the first item have thermal insulation for the turbine B, the condensation reservoir D, the refrigeration cycle and the tubes between them.

4. Device as in the first item have simple refrigeration cycle to transfer the wasted heat from the condenser to the evaporator.

5. Device as in the first item have reservoir and valve after the pump H closes automatically when the device shuts down and check valve after the turbine B to keep reasonable amount of the cooling medium to help the device auto start mechanism
